(19) United States
(12) Patent Application Publication
(10) Pub. No.: US 2025/0111293 A1
(43) Pub. Date: Apr. 3, 2025

(54) SYSTEMS AND METHODS FOR AUTOMATIC CARBON INTENSITY CALCULATION AND TRACKING

(71) Applicant: Gevo, Inc., Englewood, CO (US)

(72) Inventors: Patrick Richard Gruber, Longmont, CO (US); Christoph Impekoven, Frankfurt (DE)

(21) Appl. No.: 18/978,902

(22) Filed: Dec. 12, 2024

Related U.S. Application Data
(63) Continuation of application No. 17/729,679, filed on Apr. 26, 2022.
(60) Provisional application No. 63/180,309, filed on Apr. 27, 2021.

(51) Int. Cl. G06Q 10/063

(52) U.S. Cl. CPC G06Q 10/063

(57) ABSTRACT

Examples of the present disclosure describe systems/methods for automatically generating and tracking a carbon intensity (CI) score assigned to a particular product as the product traverses through a processing plant and discrete steps in a supply chain. In some examples, intermediate CI scores may be assigned to the product as it completes each step in its life cycle. The intermediate CI scores may be aggregated to produce a final CI score. Each intermediate CI score is recorded on a blockchain, such that the CI score is independently verifiable and auditable. In other example aspects, a machine-learning model may be applied to the input data received from each supply chain stakeholder and CI scores, wherein the machine-learning model generates intelligent suggestions to stakeholders for how to tweak their processes to lower CI scores. In other examples, a CI score may be used to derive a value for a CI token.

### CROSS REFERENCE TO RELATED APPLICATION(S)

This application is a continuation application of and claims priority of U.S. patent application Ser. No. 17/729,679, filed Apr. 26, 2022, which claims priority to and the benefit of U.S. Provisional Application No. 63/180,309, filed Apr. 27, 2021, the disclosure of which is incorporated herein by reference.

### TECHNICAL FIELD

The present disclosure relates to the fields of carbon intensity tracking, blockchain systems, and smart contracts.

### BACKGROUND

Present day entities seeking to reduce their carbon footprint struggle to measure and verify the environmental impact of their business operations—from corporate headquarters to global operations to supply chains. For example, customers wishing to purchase environmentally-friendly products usually must rely on the word of the supplier, as the ability to transparently audit and verify the environmental impact of certain products is difficult with present day climate accounting technology. As more corporations continue to make climate pledges, holding these corporations accountable becomes increasingly important.

A key objective of some “green product” providers is to efficiently and accurately substantiate environmental marketing claims (e.g., as required under 16 C.F.R. Part 260, “Guides for the Use of Environmental Marketing Claims”), to support monetization of such marketing claims, to protect against allegations of false claims (e.g., “green-washing”), and to secure economic value based on the costs incurred in producing green products.

Gathering data from different vendors—from energy use and possible carbon—and using it to determine emissions has been challenging due to the lack of comprehensive standards for carbon accounting or a single set of guidelines on how to audit, verify, and report carbon emissions throughout a supply chain. One present day method of climate accounting involves carbon credits, which involves accounting for the changes in feedstock, manufacturing processes, and handling of products that affect carbon intensity (i.e., carbon emitted per unit of feedstock, process, or handling). A carbon credit is one metric ton of carbon dioxide or an equivalent amount of a different greenhouse gas (e.g., utilizing global warming potentials to convert carbon dioxide equivalent values). In a cap and trade system, a business is assigned a certain number of carbon credits. If the business will emit more greenhouse gases than their cap, they must purchase carbon credits to offset their over production of greenhouse gases. Carbon credits can be purchased directly from a business that is producing less than their cap or from an exchange which aggregates excess carbon credits. Another carbon market mechanism may include a scenario where an entity is required to purchase carbon credits (e.g., as required by the Regional Greenhouse Gas Initiative (RGGI). Such carbon credit markets may exist in compliance and non-compliance (i.e., voluntary) environments, where certain carbon tracking is tracked against internal performance criteria as opposed to regulated criteria.

Carbon credits that are not purchased from businesses that use less than their cap are obtained from projects that pull greenhouse gases out of the atmosphere or from projects that produce less greenhouse gases than the current alternative. An example of a project that produces less greenhouse gases than the typical method would be a project that is normally powered by burning coal, but the coal has been replaced with an energy source without greenhouse gas emissions such as solar power. An example of a project that pulls greenhouse gases from the atmosphere is a carbon capture project such as planting a forest. One challenge with carbon credits and carbon offsets, however, is ensuring that a purchase of carbon credits is indeed a purchase of carbon credits that have not already been purchased by another entity. Because a trustworthy end-to-end and fully auditable solution does not exist today, double purchasing on carbon credits is a frequent occurrence. Another challenge is adequately substantiating the claims associated with carbon credits, such as determining the date, location, input technology, and other characteristics of the origin of the carbon credit.

An existing method of measuring carbon emissions today is a carbon intensity (CI) score, or a direct carbon value (DCV), as it is referred to in Europe. A CI score is calculated based on the amount of carbon dioxide produced during the process of growing and processing a crop into a biofuel. Currently, in some jurisdictions, the crop used to produce a biofuel at a particular plant is aggregated and assigned a CI score despite differences in growing methods (e.g., g/MJ (megajoule), g/TJ (terajoules), etc.). No consideration is taken for differences in growing methods and transportation. As a result, carbon credits that are derived from CI scores may not accurately reflect the carbon emissions that are being reduced (or not reduced). Little documentation is retained to determine if the CI score from a certain crop grower accurately reflects the crop grower's production methods, for example.

Another issue with carbon credits is the inefficiency in exchanging/trading the carbon credits. Buyers and sellers are usually unable to verify and validate the true value of a carbon credit and, at the same time, audit the carbon credit's value (i.e., determine that the carbon credit is derived from a legitimate environmentally conscious and carbon-friendly process). Buyers and sellers also usually must wait several days before their carbon credits are transferred and settled. As such, there is a need to more efficiently and transparently verify the value of a carbon credit and transfer it between entities.

One facet of the present application is blockchain-based technology, and more generally, distributed ledger technology (DLT). A blockchain is a continuously growing list of records, called blocks, which are linked and secured using cryptography. Each block may contain a hash pointer as a link to a previous block, a timestamp, and transactional data (e.g., each block may include many transactions). By design, a blockchain is inherently resistant to modification of already-recorded transactional data (i.e., once a block is appended to the blockchain, it cannot be changed). Additional blocks may be appended to a blockchain, where each additional block (i.e., “change”) may be recorded on the blockchain. A blockchain may be managed by a peer-to-peer network of nodes (e.g., devices) collectively adhering to a consensus protocol for validating new blocks. Once recorded, the transaction data in a given block cannot be altered retroactively without the alteration of all previous blocks, which requires collusion of a majority of the network nodes.

A public, permissionless blockchain is an append-only data structure maintained by a network of nodes that do not fully trust each other. A permissioned blockchain is a type of blockchain where access to the network of nodes is controlled in some manner, e.g., by a central authority and/or other nodes of the network. All nodes in a blockchain network agree on an ordered set of blocks, and each block may contain one or more transactions. Thus, a blockchain may be viewed as a log of ordered transactions. One particular type of blockchain (e.g., Bitcoin) stores coins as system states shared by all nodes of the network. Bitcoin-based nodes implement a simple replicated state machine model that moves coins from one node address to another node address, where each node may include many addresses. Furthermore, public blockchains may include full nodes, where a full node may include an entire transactional history (e.g., a log of transactions), and a node may not include the entire transactional history. For example, Bitcoin includes thousands of full nodes in all of the nodes that are connected to Bitcoin.

With the advent of decentralized blockchains came decentralized finance, or “DeFi.” DeFi is an umbrella term for de-centralized permissionless financial infrastructure, wherein a variety of cryptocurrency-based financial applications operate. What makes these applications decentralized is that they are not managed by a central institution, but instead, the rules of these applications are written in code, and the code is open to the public for anyone to audit. These rules written in code are known as “smart contracts,” which are programs running on a blockchain that execute automatically when certain conditions are met. DeFi applications are built using smart contracts. DeFi applications can be viewed as a cluster of second layer decentralized applications (e.g., DApps) running on top of a blockchain.

It is with respect to these and other general considerations that the aspects disclosed herein have been made. Also, although relatively specific problems may be discussed, it should be understood that the examples should not be limited to solving the specific problems identified in the background or elsewhere in the disclosure.

### BRIEF DESCRIPTION OF THE DRAWINGS

Non-limiting and non-exhaustive examples are described with reference to the following Figures.

FIG. 1 illustrates an example of a distributed system for automatically generating and tracking a CI score.

FIG. 2 illustrates an example distributed blockchain architecture for automatically generating and tracking a CI score.

FIG. 3 illustrates an example input processing system for implementing systems and methods for automatically generating and tracking a CI score.

FIG. 4 illustrates an example method for automatically generating and tracking a CI score.

FIG. 5 illustrates an example method for validating a CI score on a blockchain.

FIG. 6 illustrates an example method for providing an intelligent suggestion for decreasing a CI score.

FIG. 7 illustrates an example environment for automatically generating and tracking a CI score.

FIG. 8 illustrates example inputs and outputs used to automatically generate and track a CI score along a supply chain.

FIG. 9 illustrates an example state diagram used for automatically generating and tracking a CI score.

FIG. 10 illustrates an example environment from which data is captured for automatically generating and tracking a CI score.

FIG. 11 illustrates an example environment for automatically generating and validating a CI score.

FIG. 12 illustrates an example environment for generating a CI token via a CI score.

FIG. 13 illustrates an example environment for generating a CI token using the Corda application.

FIG. 14 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Embodiments of the present application are directed to systems and methods for automatically generating and tracking a carbon intensity (CI) score. Additionally, the present application also describes example embodiments of generating a CI token that has a value derived from a CI score. In yet further examples, the present application is directed to generating dynamic and intelligent suggestions for lowering a CI score as a product moves through a supply chain using at least one machine learning (ML) algorithm.

In one example, a method for tracking a CI score associated with a particular crop using a distributed ledger is described. As the crop traverses through a supply chain, the CI score associated with the crop may update based on certain inputs, such as how the crop is harvested and how the crop is processed into an end product, e.g., biofuel. Relevant information about a crop and subsequent biofuel is continuously added to the distributed ledger as the crop is, for example, harvested, transported to a production facility, processed into biofuel, blended, transported, sold, and ultimately consumed. Other examples may include utilizing the biofuel for electricity and hydrogen. Information may be captured on a blockchain, and the information may be input (e.g., by a farmer, plant operator, processor, etc.) using a device (e.g., IoT device). The CI score associated with a particular product (e.g., batch of corn) may continually evolve along the supply chain, with the CI score becoming finalized upon delivery of the end product (e.g., jet fuel) to a customer. The finalized CI score may be captured in a certificate and stored on the blockchain. The certificate may then be used to generate an exchangeable CI token with value directly correlated to the CI score recorded on the certificate. The CI token may hold value as long as the token is not used/applied to offset actual carbon emissions. Once the CI token is applied to offset actual carbon emissions, the CI token may be “burned.”

In some examples, intermediate CI scores may be calculated at certain locations in the supply chain. CI scores (e.g., attributes) may be transacted independently of the physical underlying good (e.g., corn). For instance, these intermediate CI scores may be combined and re-combined at or before the point of final consumption. The intermediate CI scores may be used as inputs to a machine learning model for generating intelligent suggestions to lower the CI score in the next step, or a subsequent step, in the supply chain. For instance, if an intermediate CI score is unusually high for the particular location in the supply chain, a machine learning algorithm may suggest a certain adjustment (e.g., using solar for electricity instead of fossil fuels) in the next step in the supply chain in an attempt to lower the CI score, or at least slow down the increase of the CI score. The systems and methods described herein may determine which crop load should be paired with which processing techniques and energy sources to produce a biofuel with a specific CI score and monetary cost. The energy sources that may be recommended by the machine learning algorithm may alternate between green energy sources and conventional energy sources at the plant, depending on the present CI score of the product, as well as the input constraints of the present participant (e.g., farmer, shipper, processor, plant operator, refiner, buyer, etc.) in the supply chain (e.g., the ML algorithm will not suggest use of solar energy if the present factory in the supply chain is not equipped to use solar power). In other example aspects, the systems and methods described herein can track energy sources within a particular plant that is processing a good (e.g., corn). The energy sources may be tracked minute by minute, hour by hour, etc. Such energy sources may comprise wind, combined head and power (CHP) electricity, biogas, renewable natural gas (RNG), natural gas, grid electricity, and/or a combination of the aforementioned.

In another example, a machine learning model may be used to provide intelligent suggestions to a previous participant in the supply chain. For instance, if a CI score was uncharacteristically high at a certain location in the supply chain, the machine learning algorithm may suggest certain optimization methods to a past participant (or previous process) so the past participant can implement these optimization methods in the future, which will in turn, hopefully lower the CI score at that point in the supply chain. The lower the CI score, the more value a generated CI token will have (i.e., efficient markets may drive CI scores lower). It should be appreciated that the teaching herein can be applied to not only achieve a lower CI score, but to also achieve a target CI range, or to stay below a target CI threshold.

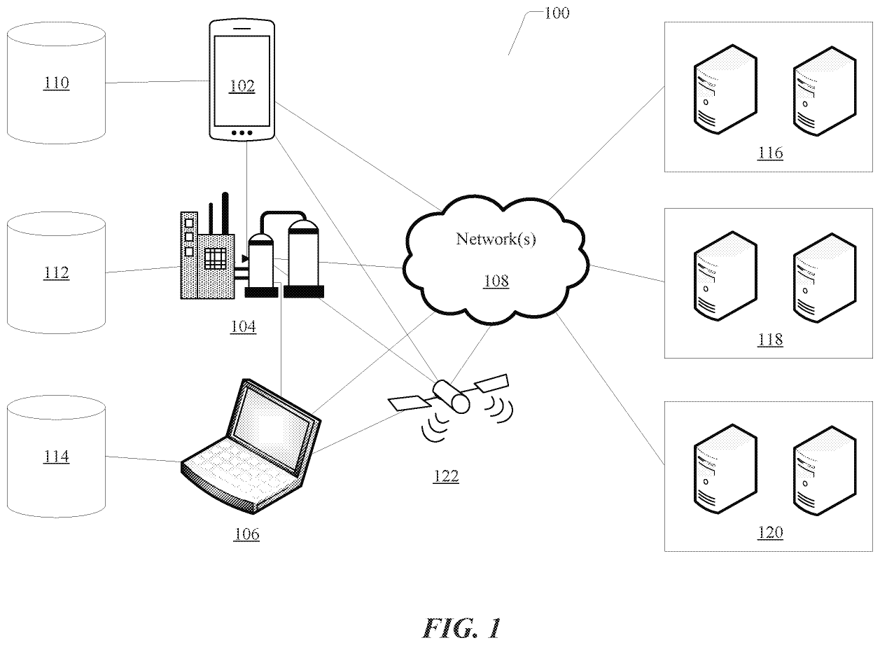

FIG. 1 illustrates an example of a distributed system for automatically generating and tracking a CI score. Example system 100 presented is a combination of interdependent components that interact to form an integrated whole for automatically transferring an asset based on one or more smart contracts. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and/or 106 may be configured to receive and transmit information related to a product traversing a supply chain, as well as a CI score associated with that particular product. The CI score may continually evolve as the product continues through the supply chain, the CI score being updated on a blockchain that may be stored and accessed by client devices 102, 104, and/or 106. Client devices 102, 104, and/or 106 may also be configured to communicate within a blockchain network, as well as host a copy of a blockchain locally in local databases 110, 112, and/or 114. On top of the blockchain may reside a DeFi application that the client devices 102, 104, and/or 106 are configured to run (and/or interact with). In one example, a client device 102 may be a mobile phone, client device 104 may be an IoT device at a factory (e.g., monitoring device on a conveyer belt within a factory), and client device 106 may be a laptop/personal computer. Other possible client devices include but are not limited to tablets, smart devices/sensors, unmanned aerial vehicles (e.g., for capturing aerial footage of processing steps), unmanned land vehicles (e.g., for monitoring processing steps of certain machines used in a supply chain), etc.

In some example aspects, client devices 102, 104, and/or 106 may be configured to communicate with a satellite, such as satellite 122. Satellite 122 may be a satellite (or multiple satellites) within a cellular system. Client devices 102, 104, and/or 106 may receive data via cellular protocols from satellite 122. The cellular data received by client devices 102, 104, and/or 106 may be stored local databases 110, 112, and/or 114. Additionally, such cellular data may be stored remotely at remote servers 116, 118, and/or 120. In other examples, client devices 102, 104, and/or 106 may be configured to communicate with one another via near-range communication protocols, such as Bluetooth.

Client devices 102, 104, and/or 106 may also be configured to run software that implements (and/or interacts with) a blockchain with at least one DeFi application for automatically generating and tracking a CI score associated with a product in a supply chain, as well as validating a CI score once it is finalized. Furthermore, client devices 102, 104, and/or 106 may be configured to run software that generates intelligent suggestions for reducing a CI score using at least one ML model that has access to the present processing techniques and input data for processing a particular product/raw material in a supply chain. For instance, generation of intelligent suggestions may depend on information gathered from information (e.g., farming techniques, plant operator energy sources, etc.) already stored on at least one blockchain and/or other traditional stores of information, such as a database. In some examples, characteristics of each participant in the supply chain may be stored as a “state” within a blockchain, where the state of the participant includes information identifiers with values that may be accessed by the system to determine a particular CI score and/or predict a future CI score. The same states of these participants in the supply chain may also be accessed by at least one ML model to generate intelligent suggestions for reducing a CI score at each step in the supply chain. By way of example, a participant who puts an intelligent suggestion into practice (e.g., changes electricity at a factory from fossil fuels to solar) may record a new “state” for that participant, which may affect future CI scores associated with future products moving through the supply chain.

For example, during initial setup, a participant in the supply chain may provide certain information to the system via client device(s) 102, 104, and/or 106. The system may process that information to construct a “state” of that participant. The state of that participant may be stored remotely on server(s) 116, 118, and/or 120, and/or locally at databases 110, 112, and/or 114. The state profile may be stored as a block on the blockchain. A participant may observe the states of other participants in the supply chain over network(s) 108 or satellite 122. For instance, a participant may be a government entity (e.g., regulator) that is verifying the state information of a certain participant in the supply chain. Accessing such state information may be provided via a DeFi application running on top of the blockchain.

One or more smart contracts may also reside on the blockchain network. Copies of the smart contract(s) may be stored locally at local databases 110, 112, and/or 114, as well as remotely at servers 116, 118, and/or 120. The smart contract may determine how much an end consumer pays for the end product based on the end product's finalized CI score. For example, a consumer who contracts with a supplier to buy a certain product with a certain CI score may receive a product with a higher or lower CI score. A smart contract stored on the blockchain may automatically adjust payment between the supplier and customer based on the finalized CI score. If the customer desired to purchase a product with a lower CI score but received a product with a higher CI score, then the customer may automatically receive a discount according to the terms of the smart contract. If a product has a lower CI score than expected, then the customer may pay a premium for the lower CI score product or elect to not take possession of the product (e.g., standard fuel purchase agreement), in some examples. Assets to be transferred between an end customer and a supplier may be placed in escrow on the blockchain. For example, the smart contract may be a smart contract between a fuel supplier and an airliner (customer). Based on the aggregate CI scores associated with each unit of jet received by the airliner, the escrowed assets of the airliner may be transferred to the jet fuel supplier automatically based on certain conditions being met on the smart contract. For example, if the aggregate CI score is 1 point higher than expected, a certain amount of assets are deducted from the agreed-upon amount to be transferred from the escrow account (e.g., wallet) to the supplier account (e.g., wallet). The transaction may be recorded as a block on the blockchain, which ensures the integrity of the claims regarding carbon benefits in the supply chain.

Additionally, the systems and methods described herein may implement at least one ML model that has access to at least one database of historical processing techniques that have proven to lower CI scores. For example, the database may comprise information regarding the average decrease in CI score by transitioning from fossil-fuel-powered machinery to hydro-powered machinery. Such data may be accessed by client device(s) 102, 104, and/or 106 via network(s) 108 and/or satellite 122. The database(s) may also be stored locally at database(s) 110, 112, and/or 114.

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to query a DeFi application running on top of a blockchain to receive an update on the current CI score of a certain product (e.g., bushel of corn) and a predicted CI score of the certain product based on the future processing steps in the supply chain. A graphical user interface associated with a DeFi application may display on the mobile device 102 indicating a CI score tracker, as well as the forecasted value to be captured in a CI token after the CI score is finalized and certified.

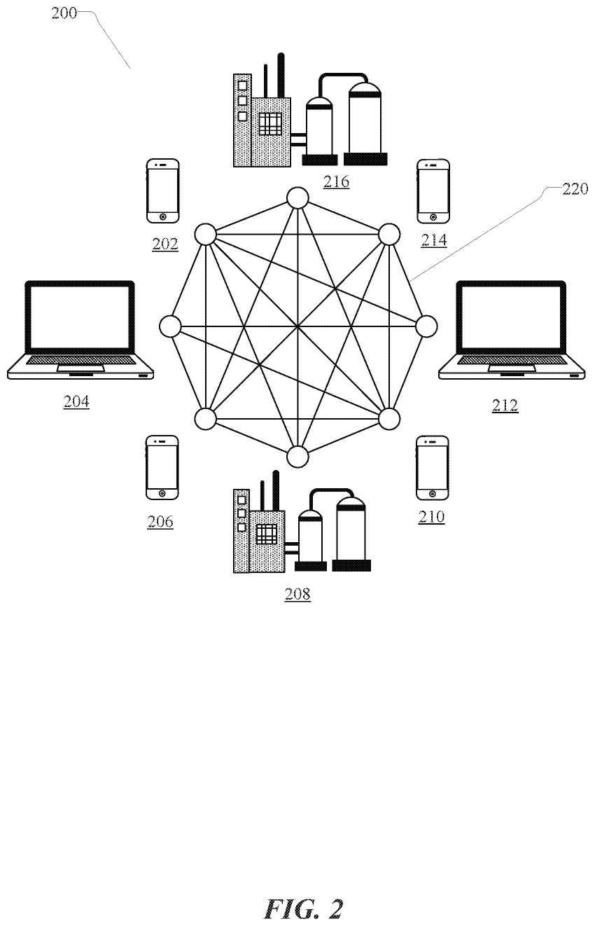

FIG. 2 illustrates an example distributed blockchain architecture for automatically generating and tracking a CI score. FIG. 2 is an alternative illustration of a distributed system 200 like system 100 in FIG. 1. In FIG. 2, each of the network devices are interconnected and communicate with one another. Each device in the network has a copy of the blockchain (or at least a partial copy of the blockchain, e.g., light nodes), as the blockchain is not controlled by any single entity but rather a distributed system, in some examples. In other examples, the blockchain may be a permissioned blockchain that includes an access-control layer, preventing and allowing some devices to read and write certain information to the blockchain.

Specifically, in FIG. 2, mobile devices 202, 206, 210, and 214 are connected with laptops 204 and 212 and “smart” factories 208 and 216 (e.g., an IoT device at a processing plant or factory, such as a monitoring device on machinery within a factory) within the distributed system 200. The devices depicted in FIG. 2 communicate with one each other in the blockchain network 220. Each node may store a local copy of the blockchain, or at least a portion of the blockchain. For example, laptop 204 may query the blockchain in the blockchain network, and a server may receive the query and produce a block from the copy of the blockchain that is stored on the server. Laptop 204 may receive the information located within the block (e.g., current CI scores, projected CI scores, ML-based suggestions for lowering CI score, etc.). In short, the systems and methods described herein may be implemented within a distributed architecture as displayed in FIG. 2, and in some examples, implemented on a single node within the distributed blockchain network.

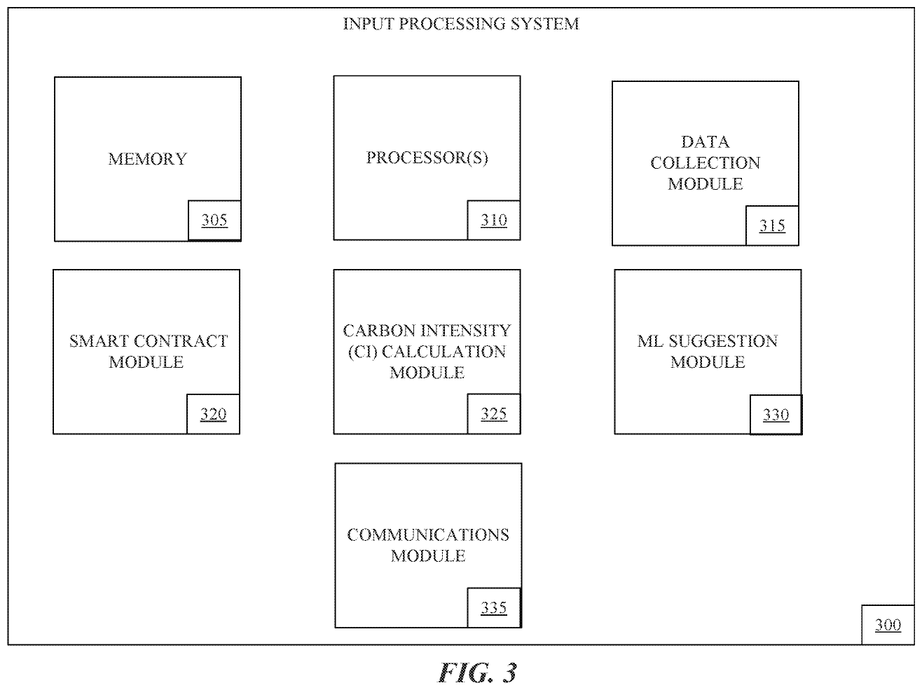

FIG. 3 illustrates an example input processing system for implementing systems and methods for automatically generating and tracking a CI score. The input processing system (e.g., one or more data processors) is capable of executing algorithms, software routines, and/or instructions based on processing data provided by a variety of sources related to generating and tracking a CI score, as well as generating intelligent suggestions to entities within a supply chain for decreasing a particular product's CI score. The input processing system can be a general-purpose computer or a dedicated, special-purpose computer. According to the embodiments shown in FIG. 3, the disclosed system can include memory 305, one or more processors 310, data collection module 315, smart contract module 320, carbon intensity (CI) calculation module 325, machine leaning (ML) suggestion module 330, and communications module 335. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 305 can store instructions for running one or more applications or modules on processor(s) 310. For example, memory 305 could be used in one or more embodiments to house all or some of the instructions needed to execute the functionality of data collection module 315, smart contract module 320, CI calculation module 325, ML suggestion module 330, and communications module 335. Generally, memory 305 can include any device, mechanism, or populated data structure used for storing information, including a local copy of a blockchain data structure. In accordance with some embodiments of the present disclosures, memory 305 can encompass, but is not limited to, any type of volatile memory, nonvolatile memory, and dynamic memory. For example, memory 305 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 305 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 305. In some example aspects, memory 305 may store at least one database containing present CI scores for particular products, certain CI score thresholds based on regulatory information (e.g., CI score threshold for determining a tax credit in a particular territory/state), historical average CI scores for certain products, average decrease or increase of CI scores based on certain processing techniques, etc. In other examples aspects, memory 305 may store at least one copy of a blockchain with at least one DeFi application running on the blockchain. In yet other example aspects, memory 305 may store assets (e.g., fungible or non-fungible CI tokens, stablecoins, etc.) that may be submitted to a blockchain via a DeFi application. In other aspects, memory 305 may be configured to store at least one present CI score and a predicted supply chain path, wherein the predicted supply chain path and present CI score are used as inputs to generating intelligent ML-based suggestions to reduce the CI score as the product(s) traverse the supply chain. Any of the data, programs, and databases that may be stored in memory 305 may be applied to data collected by data collection module 315.

Memory 305 may also be configured to store certain “states” of products and manufacturing/processing techniques. For instance, a certain farm may have previously utilized a harvesting technique that relied on fossil fuels (state A). If the farm changes its harvesting technique to rely on renewable energy sources rather than fossil fuels, then its state may be updated and stored in memory 305 (state B). Further, memory 305 is configured to record the CI score of a product or products as they move through the supply chain. At each step of the supply chain, a CI score is captured and recorded. For example, a pre-processing and post-processing CI score may be captured at each supply chain step, which may be used to accurately verify the finalized CI score once the end consumer receives the final product. The finalized CI score may be used in determining a value for a CI token. To accurately determine the value of the CI token, the system described herein may rely on an accurate and verifiable audit trail of a CI score to establish provenance. The audit trail of a CI score may be stored in memory 305, where, for example, the memory 305 may be storing a copy of a blockchain which has the CI scores recorded at each step of the supply chain as individual, immutable blocks appended to the blockchain. In some examples, to ensure the immutability of the blocks, each block must be signed (i.e., agreed/accepted) by all required signers. Once all signatures are gathered, then a block may become committed, and the inputs to that block may be marked as historic (e.g., in a supply chain). In addition to CI scores, other data related to a location may be captured and stored on the blockchain, including aerial images of farmland (e.g., to ensure that acreage has not increased or decreased).

Data collection module 315 may be configured to collect data associated with at least one process within a supply chain. For instance, data collection module 315 may be configured to receive data associated with a farmer's cultivation practices, a machine's use of fossil fuels vs. renewable energy, a fermentation technique, types of vehicles involved in the shipping process (e.g., whether they are electric vehicles or combustion-engine driven), and the like. Other information that may be received by data collection module 315 may include locational, operational, production, environmental, social, governance, yield, and/or financial performance data associated with commodity production. Such information may be received by data collection module 315 automatically through client devices and/or trusted third-party sources (e.g., a farmer may input data regarding a farming technique into a third-party application that then stores the data and transmits the data to data collection module 315 or, alternatively, makes the data available for observation and analysis via data collection module 315). Data collection module 315 may also be configured to query at least one database associated with historical processes in a supply chain. In some examples, the processes may be categorized according to product that is being produced and/or industry. The historical processes may include state information, including discrete processing steps and inputs used by certain participants in a supply chain. Additionally, the historical data in the database may comprise CI scores of certain products that were generated at that point in time in the supply chain. The database may also reflect how CI scores changed as the associated product flowed through different steps in the supply chain (e.g., certain processes in the supply chain led to a lower CI score, whereas other processes in the supply chain increased the CI score). The historical processing of such supply chain data and CI scores may comprise historical trends of successful and unsuccessful attempts to lower the CI scores from past participant processing methods (e.g., applying new type of fermentation technique, replacing gas-powered machinery with EV-powered machinery for harvesting, etc.). Data collection module 315 may also be configured to receive real-time updates regarding a CI score at a certain step within the supply chain. For instance, after a product moves to the subsequent step in the supply chain, this status update may be recorded on the blockchain, and a new CI score may be recorded based on the previous processing step that was applied to the product. After a product is processed at a new step in the supply chain, a new CI score may be updated (and recorded on the blockchain) based on data captured by data collection module 315. Similarly, when a CI score is finalized and used to create a CI token, the information associated with the value of the CI token (e.g., a complete, immutable audit trail of the product's processing steps through the supply chain, exhibiting how the CI score of that product evolved at each step) may be stored on the blockchain and received by data collection module 315.

For example, a net-zero processing plant may be expected to obtain a particular CI score based on its inputs (e.g., that are recorded in a state within a state diagram on the blockchain). In one instance, a net-zero plant may be expected to utilize wind electricity, biogas generated onsite from waste water (e.g., to reduce the use and reliance of fossil-fuel-based natural gas), electricity generated from biogas that is also generated onsite, renewable natural gas brought to the site (which may be characterized by a different CI score than the biogas that is generated onsite), grid electricity, and fossil-fuel natural gas. Other inputs that may affect the CI score at a particular stage in the supply chain includes transportation methods, ancillary equipment operations (tractors, loaders, etc.), elevator operations, transport of intermediate products, transport of final products, etc. The CI score that may be produced from this net-zero plant may be affected by the extent of the use of each of the aforementioned energy inputs. Based on the current CI score of the good(s) arriving at the net-zero plant and the projected CI score of the processed good(s) in later stages in the supply chain, a particular mix of energy inputs may be determined at the net-zero plant to produce a CI score that maximizes both energy and economic efficiency (i.e., balancing carbon emissions and cost).

Alternately, data collection module 315 may interrogate, or otherwise solicit data from, one or more data sources comprising such information (e.g., other nodes in a network). For example, data collection module 315 may have access to data in one or more external systems, such as content systems, distribution systems, marketing systems, supply chain participant/entity/partner profiles or preference settings, authentication/authorization systems, device manifests, or the like. Specifically, data collection module 315 may have access to at least one database of historical CI score data and up-to-date CI score data and analyses (e.g., analyses regarding the environmental impact-including predicted CI scores for particular products—of applying certain processes in a supply chain, etc.), which may inform the system as to which step within a supply chain a certain product should be shipped to next that may provide the product's CI score the most optimal chance of lowering its CI score or, alternatively, limiting the increase in the CI score as compared applying other processes to the product. Data collection module 315 may use a set of APIs or similar interfaces to communicate requests to, and receive response data from, such data sources. In at least one example, the data collection process of data collection module 315 may be triggered according to a preset schedule, in response to a specific user request to collect data (e.g., user wants to know the current CI score of a certain batch of a larger product group currently traversing a supply chain), or in response to the satisfaction of one or more criteria (e.g., a push notification is sent to a certain entity after an updated CI score for a product reveals the CI score exceeds a particular threshold).

Smart contract module 320 may be configured to receive data from data collection module 315 (e.g., in a spreadsheet format, database table, etc.). The data received by smart contract module 320 may allow the smart contract module 320 to construct at least one smart contract between an entity in the supply chain and the system described herein. The smart contract may be for generating a CI score. Thus, for instance, an entity in the supply chain (e.g., a farmer) who acquiesces to the terms of the smart contract (i.e., discrete formulas for calculating a CI score based on the particular product of interest and particular inputs provided by the farmer and/or IoT devices monitoring farmer's equipment) will enter into an agreement with the CI score generation and tracking system described herein, agreeing that the generated CI score is correct. For example, initial data received by the smart contract module 320 may be contract terms (i.e., rules) for calculating carbon intensity (CI). Additional contract terms may be provided in some instances, such as certain terms required by customers (e.g., smart contract may contain term for customer to automatically reject certain products above a maximum CI-score threshold). In such an example, the contract terms calculating the immutable CI score is distinct from the additional contract terms. However, the initial generation/calculation of the CI score may be used as an input value in determining whether certain additional customer-specific smart contract terms are triggered. In another example, a supplier and producer may agree that certain products that show a CI score below a particular threshold automatically result in a premium charge for the product. Based on the smart contract calculation of the CI score, a certain supplier may automatically receive a higher price for the end products because of the products' lower CI score (i.e., more valuable products to the end customer). In examples, the smart contract (e.g., operating via a DeFi application on top of a blockchain) may have access to a third-party application monitoring the use of certain processes and machinery by entities in the supply chain. Based on the information received from monitoring the use of certain processes and machinery (which may be collected by data collection module 315 and provided to smart contract module 320), certain smart contract terms can be triggered automatically.

In another example, the smart contract module 320 may be configured to trigger the transfer of funds from an escrow wallet to an end-customer wallet and vice versa. For instance, if a malfunction occurs in the delivery of a product, a smart contract rule may require that a certain amount of assets (e.g., fiat, cryptocurrency, etc.) be transferred from a supplier wallet address to an end-customer wallet address. Conversely, once products are delivered successfully and are verified with particular CI scores, the smart contract module 320 may be configured to trigger an automatic payment from the end customer to the supplier.

In yet another example, smart contract module 320 may be configured to interact with carbon intensity (CI) calculation module 325. CI calculation module 325 may be configured to receive real-time inputs from certain participants in a supply chain, such as state information of a certain farm, processing plant, manufacturing facility, packaging supplier, etc. Such state information may contain information as to how a certain participant in the supply chain is intending to process a particular product at that stage in the supply chain. Information may include what types of energy are being used to power machinery at a facility, whether certain environmentally-friendly techniques are being applied, tillage practices, application rates of agricultural chemicals (e.g., fertilizers, herbicides, pesticides, etc.), types of agricultural chemicals applied to crop(s), information derived from soil audits (e.g., from third-party auditors and/or sensors), and other carbon offset measurements.

In some examples, the CI calculation module 325 may be configured to calculate a CI score based on inputs from the participants in the supply chain in combination with regulatory and standardized algorithms for calculating CI scores. A person of ordinary skill in the art will appreciate that CI score calculations are standardized according to jurisdiction. For instance, the U.S. state of California calculates CI scores according to life-cycle analysis, which is an analytical method for estimating the aggregate quantity of greenhouse gases emitted during a full fuel life cycle. The GHG Protocol calculates CI scores as CO₂ emissions per functional energy unit of a product. The Environmental Protection Agency utilizes a Greenhouse Gases Equivalencies Calculator (e.g., CA.GREET 3.0). Other jurisdictions and organizations measure carbon intensity as weight of carbon per British thermal unit (Btu) of energy. Further examples of calculating CI include the Argonne National Laboratory's GREET model, including GREET model variations that are implemented by certain jurisdictions and entities such as the state of California, International Civil Aviation Organization (ICAO), and the European Union (e.g., Renewable Energy Directive (RED and REDID). Each of the aforementioned calculation methodologies have differences in assumptions and may not allow for carbon credits to be traded equally across the carbon markets.

The CI calculation module may be configured to communicate with smart contract module 320, as certain contract terms from smart contract module 320 may determine how the CI score is calculated by CI calculation module 325. For example, smart contract module 320 may contain a certain algorithm without any inputs from the participants in the supply chain, but CI calculation module 325 may receive those inputs (via data collection module 315) and use those inputs in conjunction with the algorithmic terms defined in smart contract module 320 to generate (and/or update and/or finalize) a CI score for a particular product.

Smart contract module 320 and CI calculation module 325 may be configured to communicate with machine-learning (ML) suggestion module 330, and vice versa. ML suggestion module 330 may rely on information provided by smart contract module 320 and CI calculation module 325 to provide intelligent, machine-learning-model-driven suggestions to certain participants in the supply chain, specifically related to how a participant may alter its processing methods to reduce the CI score of future products. In alternative embodiments, the ML suggestion module 330 may provide real-time suggestions to the system as to which participant in a supply chain a product should be sent to next. For example, at step #3 in a supply chain, a product could be further processed at plant A or plant B. Based on the product's present CI score and the historical CI scores and state information from plant A and plant B, the ML suggestion module 330 may intelligently suggest to the system which plant (plant A or plant B) the product should be shipped to next for processing, based on a predictive output that one plant has a higher likelihood of producing a lower CI score for that particular product at the present time than the other plant.

ML suggestion module 330 may be configured to automatically make intelligent suggestions for how to optimize (i.e., lower CI scores) a supply chain by providing suggestions directly to participants and stakeholders in the supply chain regarding tweaking, substituting, and improving processes to make them eco-friendlier in order to achieve lower CI scores for an end product. Rather than manually attempting to make adjustments to a supply chain (typically with insufficient information of the supply chain as a whole), the ML suggestion module 330 may automatically make intelligent suggestions in at least two types of settings: (i) to certain participants in a supply chain based on past performance indicators (e.g., state information reflecting the present data about certain machinery and operations of a participant in the supply chain) and (ii) to the supply chain operators/controllers regarding where a certain product should be processed next based on its current CI score (e.g., a certain processing plant may be more eco-friendly than another plant, and since the CI score of the present product is at a certain threshold, the product needs to be processed at a more eco-friendly plant to ensure the product's CI score does not exceed the threshold). Such a determination may be made according to the present CI scores, historical data associated with certain participants in a supply chain, budget constraints, end-customer demands, etc. which may be received from data collection module 315 and supplied to ML suggestion module 330.

In one example, ML suggestion module 330 may suggest certain substitutions and application rates of inputs (e.g., fertilizers, pesticides, etc.), aggregation and timing of shipments (e.g., to more economically and efficiently deliver the necessary inputs at a particular stage in the supply chain), optimizing transport methods and routing, customer rotation (e.g., to promote blending of particular co-products/byproducts based on shelf-life). In other words, a stakeholder in the supply chain may receive an ML suggestion to alter its shipping methodologies, change its fuel selections used in shipping a product, change its fertilizer brand, change the application rate and amount of pesticides applied to a particular crop, etc.

In some aspects, ML suggestion module 330 may be configured with a pattern recognizer, wherein the pattern recognizer may pick up on certain historical trends to identify certain patterns (e.g., certain inputs typically reduce a CI score by X %, certain inputs typically increase a CI score by Y %, etc.). The pattern recognizer within the ML suggestion module 330 may have two modes: a training mode and a processing mode. During the training mode, the pattern recognizer may use the identified inputs that have been proven to affect CI scores of certain products to train one or more ML models. Once the one or more ML models are trained, the pattern recognizer may enter processing mode, where input data is compared against the trained ML models in the pattern recognizer. The pattern recognizer may then produce a confidence score that denotes the confidence that certain inputs in a supply chain will either increase or decrease a CI score for a particular product, with a high confidence score being associated with a higher likelihood of that particular input affecting the CI score (either negatively or positively). In other aspects, during training mode, pattern recognizer may use different types of processing, manufacturing, packaging, farming, shipping, etc. inputs from similarly-situated participants in historical supply chains to train one or more ML models to distinguish between certain data points that suggest a certain input will increase a CI score or decrease a CI score (or have no effect on a CI score). For instance, a farmer implementing machinery powered by renewable energy sources may result in a high confidence interval that this particular farmer's techniques will lower a CI score of a certain product, whereas the farmer using fossil fuels to power its machinery will have a high confidence interval of increasing the CI score of a certain product.

ML suggestion module 330 may be configured with at least one machine learning model. In some aspects, the extracted supply chain processes and features from the supply chain participant data collected by data collection module 315 may be used to train at least one machine learning model associated with the pattern recognizer during training mode. For example, to train the machine learning model, the extracted and identified supply chain participant processes may be associated with specific risk identifiers, such as increased CO₂ emissions, fossil fuel usage, hazardous waste, etc. The pattern recognizer of ML suggestion module 330 may utilize various machine learning algorithms to train the at least one machine learning model, including but not limited to linear regression, logistic regression, linear discriminant analysis, classification and regression trees, naïve Bayes, k-Nearest neighbors, learning vector quantization, neural networks, support vector machines (SVM), bagging and random forest, and/or boosting and AdaBoost, among other machine learning algorithms. The aforementioned machine learning algorithms may also be applied when comparing input data to an already-trained machine learning model. Based on the identified and extracted supply chain participant features and patterns, pattern recognizer may select the appropriate machine learning algorithm to apply to the supply chain data to train the at least one machine learning model. For example, if the supply chain features and processes are complex and demonstrate non-linear relationships, then the pattern recognizer may select a bagging and random forest algorithm to train the machine learning model. However, if the supply chain features and processes demonstrate a linear relationship to certain increases or decreases of CI scores for certain products, then pattern recognizer may apply a linear or logistic regression algorithm to train the machine learning model.

Communications module 335 is associated with sending/receiving information (e.g., collected by data collection module 315, smart contract module 320, CI calculation module 325, and ML suggestion module 330) with a remote server or with one or more client devices, streaming devices, servers, blockchain nodes, IoT devices, etc. These communications can employ any suitable type of technology, such as Bluetooth, WiFi, WiMax, cellular, single hop communication, multi-hop communication, Dedicated Short Range Communications (DSRC), or a proprietary communication protocol. In some embodiments, communications module 335 sends information collected by data collection module 315 and processed by smart contract module 320 and CI calculation module 325 (as well as ML suggestion module 330). Furthermore, communications module 335 may be configured to communicate certain terms of a smart contract from smart contract module 320, a calculated CI score from CI calculation module 325, and an automatic supply chain process improvement based on ML suggestion module 330 to a client device. Additionally, communications module 335 may be configured to communicate an updated CI score to a client device after a product completes processing at a certain step in the supply chain. The communications module 335 may also be configured to communicate a complete audit trail of the CI score evolution associated with a product, from farm to end-product. Communications module 335 may also communicate a value associated with a CI score, wherein the value may be captured in a CI token that may be exchangeable (traded, bought, and sold) by third parties in the carbon credit market.

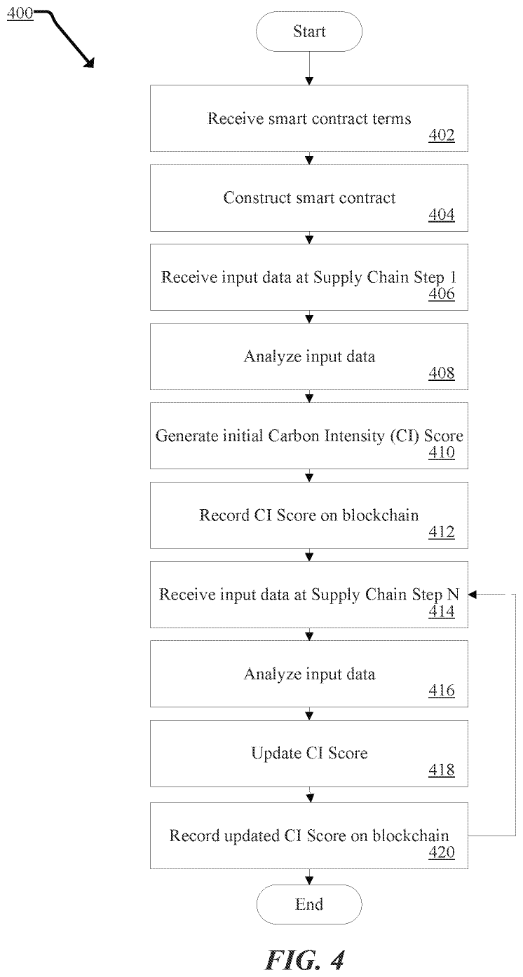

FIG. 4 illustrates an example method for automatically generating and tracking a CI score. Method 400 begins with step 402, receive smart contract terms. The smart contract terms at step 402 may define an algorithm for calculating a CI score. The calculation for the CI score may be dependent on the type of product, quantity of product, inputs from stakeholders throughout the supply chain, and other input variables that gauge the extent of a production process's eco-friendliness and its CO₂ emissions.

In other examples, the smart contract terms received at step 402 may comprise customer-specific terms, which may include price adjustments that directly correlate with the ultimate CI scores of an end-product. Other example terms may include paying premium prices for lower CI scores and rejecting possession of an end product if the end product exceeds a certain CI score threshold. In some instances, a smart contract may be setup so that an end customer remits payment to a supplier in increments based on certain CI score milestones that are achieved (or missed) during the product's journey through the supply chain. In this pay-per-step environment, payments remitted to the supplier can be based on how carbon intensive each step is in the supply chain. In a standard contract, if the payment structure was set up as a pay-per-step structure, then the remitting of payments and manual monitoring of each process in the supply chain would have to occur as frequently as the terms specified. Even daily monitoring of such a manual contract would be infeasible and cumbersome for parties to execute. With a smart contract, however, the terms can be self-executing as frequently as the parties would like. For example, every 60 seconds, the system could monitor the processing steps of a particular product and, based on the data received by the process at that point in time, transfer assets from an escrow wallet (representing the assets deposited by the end-customer) to a supplier/seller's wallet. No intermediaries (e.g., banks, financial institutions) are required.

Once the smart contract terms are received by the system at step 402, the smart contract may be constructed at step 404. Here, the smart contract may be automatically deployed on a blockchain according to the specified rules agreed to between the seller and buyer.

At step 406, the system may receive input data from a step in the supply chain. For example, at Step #1 in the supply chain, the system may receive data regarding a farmer's harvesting techniques. If the product of interest is corn, then certain inputs may be received by the system regarding the types of machinery the farmer is deploying to harvest the corn, which pesticides (if any) the farmer applied to the corn, and the soil composition in which the corn is grown. Such inputs may be captured as a “state” of the farmer in the supply chain. This state data may be received by the system at step 406. State data may be updated as the farmer's processes are updated. For example, if the farmer changed their practices (e.g., tillage techniques), the soil composition, or applied a different type of pesticide to the corn, then such updates may be reflected in an updated “state” data block.

Once the data is received by the system at step 406, the system may analyze the input data at 408. Such analysis may comprise comparing the input data to certain formulas specified by the smart contract terms (received at step 402). Further, the system may consider historical data related to that particular stakeholder in the supply chain, as well as similarly-situated stakeholders in other supply chains. Such analysis may provide the system a benchmark to which the system may compare the input data received at step 406 at supply chain Step #1.

After the input data is analyzed at step 408, an initial carbon intensity (CI) score may be generated at step 410. The initial CI score may be the output of the combination of the smart contract terms and the input data received at supply chain Step #1. This initial CI score may be stored and recorded on a blockchain at step 412, where other interested parties may be able to view the CI score and the reasoning for the CI score (i.e., the input data received by the particular participant in the supply chain and provided to the CI score formula and smart contract terms).

As the product continues to traverse the supply chain, the CI score of that product may be updated. A “product” that traverses through the supply chain may refer to a single product or a bundle of products that is being manufactured. Certain CI score formulas may be applied to single products, whereas other CI score formulas may be applied to bundled products. As the product enters the next step in the supply chain, the system receives input data at the next supply chain step (e.g., supply chain Step #2, Step #3, Step #N, etc.) at step 414 in method 400. As mentioned with regard to step 406, the data received may comprise state information regarding the participant's processes in the supply chain. In addition to the state information that may be recorded by the stakeholder itself (or a trusted third-party, e.g., auditor), the system may also receive information from pre-installed IoT devices that may be attached to certain machines or areas where processing is occurring. For instance, an IoT device could be a carbon dioxide meter that measures certain exhaust air emitting from a machine. The data captured by the carbon dioxide IoT device may be provided to the system (e.g., data collection module 315) for analysis. In another example, the IoT device could be a camera that is installed in a processing facility, where the camera is configured to capture the types of power sources used to power certain machines. For example, if a certain participant in the supply chain runs out of power in a battery, then the participant may need to resort to fossil fuel for that day to continue processing the product. Such a deviation may be captured by an IoT device (e.g., camera, machine monitoring device, device monitoring battery power, etc.). These day-to-day changes in the supply chain may be accurately captured by the system described herein, so that the CI score assigned to the product at each step in the supply chain is an accurate representation of the environmental impact of the processing/manufacturing of the product as it traverses the supply chain.

After the data is received by the system at step 414, the input data is analyzed at step 416. Similar to step 408, the input data is compared against the terms of a smart contract, wherein the CI score may be calculated, and other customer-specific terms may be considered in parallel (e.g., partial payment disbursements, notification triggering, etc.). Based on the input data and the smart contract terms, the CI score for that product may be updated at step 418. The updated CI score (also referred to as an “intermediate CI score”) may be stored on the blockchain at step 420 as an appended block for interested parties to view, audit, and verify.

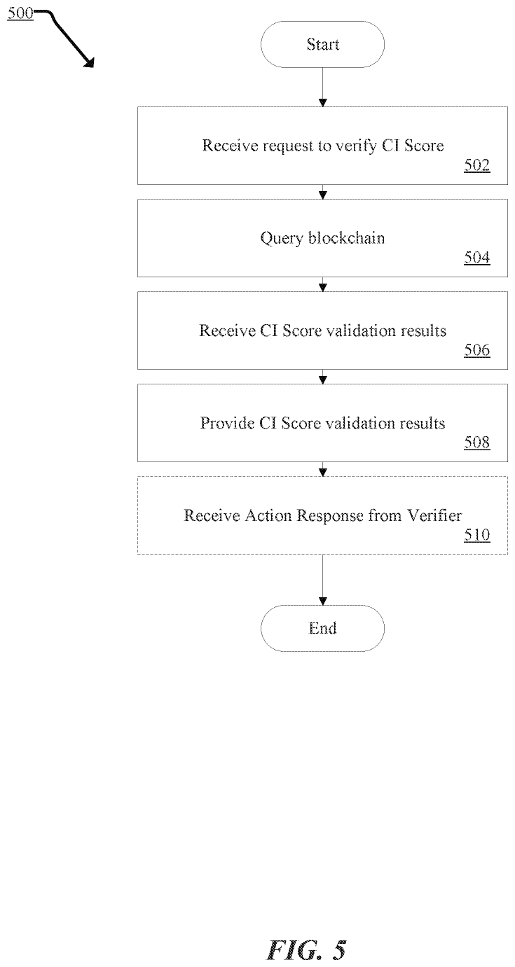

FIG. 5 illustrates an example method for validating a CI score on a blockchain. Method 500 begins with step 502, receive request to verify CI score. An application running on top of a blockchain (e.g., a DeFi application) may provide users an interface to request and verify CI scores of certain products. For instance, an end-customer may want to verify that a particular product advertised to have a certain CI score indeed has that CI score by double-checking with the CI score recorded on the blockchain. The system may receive the request at step 502, and upon receiving the request at 502, the system may query the blockchain at step 504. In some example aspects, an authentication layer may be applied prior to querying the blockchain at step 504 to ensure that authorized users are able to query the CI scores. Such an authorization layer may also be an extension of a permissioned blockchain network, as opposed to a permissionless blockchain network, in which the public could query the blockchain for CI scores.

Once the blockchain is queried at step 504, the CI scores may be received by the system at step 506. The CI score from the particular block in the blockchain will be validated and immutable. The CI score results may be provided to the verifier at step 508. Optionally, the system may receive an action response from the verifier at step 510. In some examples, the verifier may be an end-customer considering buying a certain product with a CI score. For instance, the action response the system may receive from the verifier at step 510 is a purchase action. In another example, the verifier may be a government regulator, verifying that a certain advertised CI score corresponds to the validated CI score on the blockchain. If the validated CI score is different from an advertised CI score, the verifier may flag that particular product's CI score as questionable. Flagging the CI score as questionable may be an action response received by the system at step 510.

In yet other examples, a verifier may desire to transact CI tokens. To verify the value of a CI token, the verifier may request a validated CI score. For instance, a verifier looking to purchase a CI token may first engage in due diligence on the particular CI token to verify its value by querying the blockchain and receiving results (steps 502-508). Based on the CI score provided to the verifier, the verifier may engage in purchasing a CI token associated with the CI score affiliated with that underlying product. The action response at step 510 may be purchasing, selling, and/or trading CI tokens on an exchange.

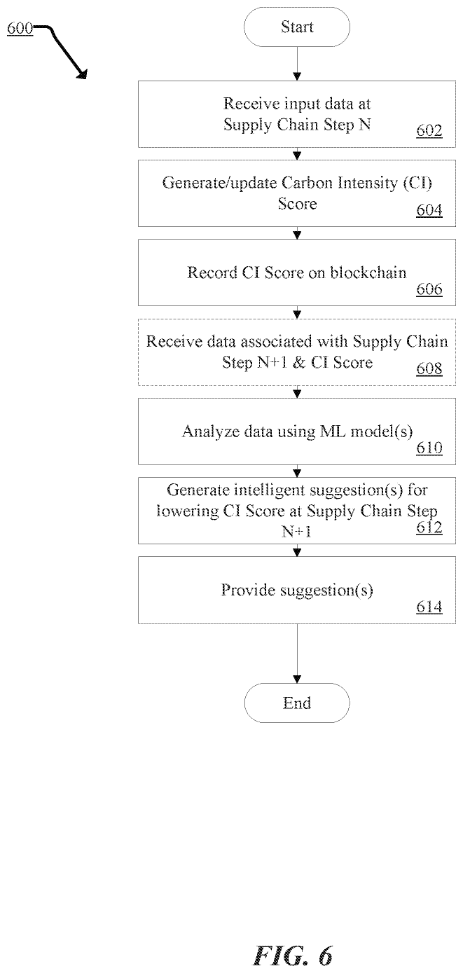

FIG. 6 illustrates an example method for providing an intelligent suggestion for decreasing a CI score. Method 600 is directed to the application of artificial intelligence (AI) and machine-learning (ML) models to the automated system of generating and tracking CI scores, described herein. Method 600 begins with step 602, where input data is received at a certain step in the supply chain (Supply Chain Step N, where “N” is a placeholder for a number). Similar to the method described in FIG. 4, this input data may be data from any stakeholder/participant in the supply chain that characterizes the processing taking place at that step. For instance, this input data could be in the form of state information, wherein certain characteristics of a farmer's harvesting techniques are captured (e.g., tillage, types of machinery used, fuel consumption, water usage, pesticide usage, etc.). Other input data may be received from IoT devices installed on certain machines and in certain environments that automatically measure and analyze the input data (e.g., CO₂ emission measurement devices, cameras, etc.). This data may be received by the system at step 602. In some examples, the input data may comprise a list of activities/inputs that have already been verified to decrease carbon emissions.

Following the reception of the input data at step 602, a carbon intensity (CI) score is generated and/or updated at step 604. If step N in the supply chain is Step #1, then the CI score will be generated, as this is the first supply chain processing information input into the system, which is required to generate a CI score. If step N is, for example, step #3, then at last two previous intermediate CI scores have already been calculated, so the results of the manufacturing/processing data at step #3 will result in an updated CI score (e.g., intermediate CI score #3). As previously described, the CI score calculation techniques are dependent on the terms of a smart contract negotiated between parties. Such smart contract terms may include calculation formulas for deriving the CI score, which may be based on industry standards and/or regulatory bodies (e.g., governments).

After the CI score is generated/updated at step 604, the CI score is recorded on the blockchain at step 606. The CI score may be recorded as a new block appended to the blockchain, as described with respect to method 400 in FIG. 4. The method 600 may then proceed to optional step 608, where data is received by the system associated with supply chain step N+1 (where “N” represents a number). Step N+1 is the subsequent step of Step N in the supply chain. The data received at step 608 is input data associated with the processing methods and techniques applied to the product at step N+1 in the supply chain. The same types of input data previously described may be collected here. Further, the participants in the supply chain at step N and step N+1 may be the same participants (e.g., different facilities managed by the stakeholder) or they may be different participants (e.g., step N is the farmer, step N+1 is the first processing plant, etc.).

Once the input data is received at step 608, the data may be provided to at least one machine-learning (ML) model at step 610. This analysis functionality at step 610 is described in detail with respect to the input processor 300 in FIG. 3. As previously described, the input data may be compared against historical data of the participant in the supply chain, as well as similarly-situated participants (e.g., peer-participants) in similar supply chains. The comparison data may also be considered by the ML model(s) at step 610. The ML model(s) is equipped with at least one pattern recognizer that may identify certain trends and inputs that affect the CI score of a certain product.

The output of the ML model(s) analysis is an intelligent suggestion, which is generated at step 612. The intelligent suggestion may suggest to a participant in the supply chain (or a third-party operator/controller) certain manufacturing/processing changes that could potentially lower a CI score in the future. Specifically, for example, after the product receives its intermediate CI score after completing step N (or step N+1) in the supply chain, the ML model output may provide a suggestion to that participant in the supply chain for tweaking its processes to potentially obtain a lower CI score in the next iteration through the supply chain.

Alternatively, the ML model may generate an intelligent suggestion for the next step in the supply chain. For instance, after receiving data associated with the present CI score, the intelligent suggestion generated by the ML model(s) at step 612 may suggest to the supply chain participants (and/or operator, controller, etc.) where to send the product next in the supply chain. For example, if multiple participants in a supply chain are available to receive and process a product in the next step in the supply chain, the system described herein may analyze and assess each of these participants to determine which participant is the most optimal for the current product based on the current product's CI score. In one example, participant A in the supply chain may be deploying state-of-the-art green technology in its processing techniques, whereby a lower CI score is more likely to be obtained than participant B who may be applying fossil-fuel-based machinery for processing. If the CI score of the product at a certain step in the supply chain is above a certain threshold, the ML model(s) output may intelligently suggest that the product be provided to participant A (instead of participant B) for the next step in the supply chain. Conversely, if the present CI score is already sufficiently low, the ML model(s) may intelligently suggest that the product be provided to participant B (instead of participant A) because, among other reasons, participant B may have cheaper processing costs than participant A—and although participant B will likely increase the CI score, the increase (based on historical data from participant B) will not be enough to substantially affect the final CI score of the product.

Once the intelligent suggestions are generated at step 612, the suggestions may be provided at step 614 to the participant(s) in the supply chain, the operators/controller(s) of the supply chain, the seller, buyer, and/or any other relevant and interested party that would benefit from receiving the intelligent suggestions based on the current state of the supply chain and current intermediate CI scores of certain products traversing the supply chain.

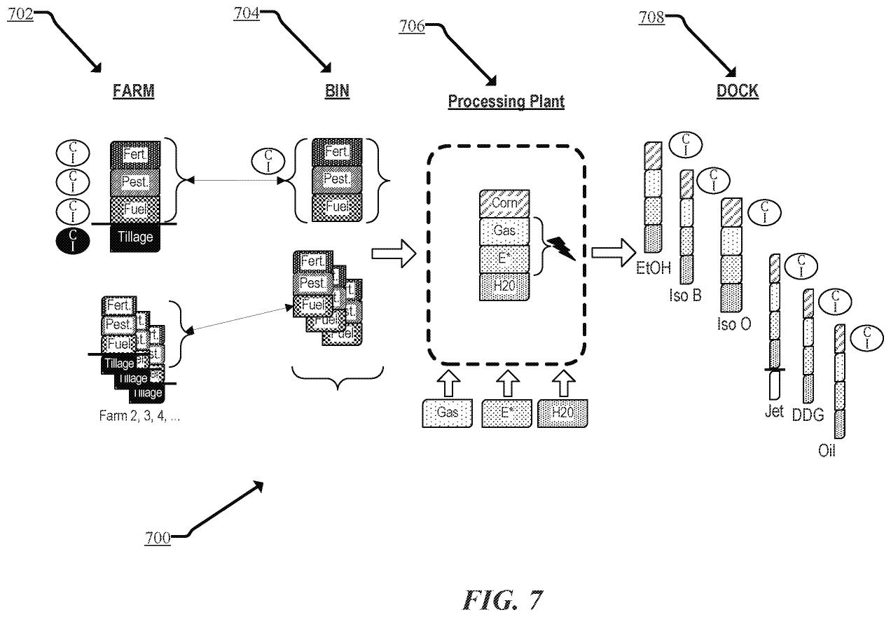

FIG. 7 illustrates an example environment for automatically generating and tracking a CI score. Environment 700 comprises a farm 702, storage bin 704, processing plant 706, and dock 708. In the example environment illustrated in FIG. 7, the inputs at the farm comprise fertilizer, pesticide, fuel, and tillage. Each of these inputs at the farm 702 have an associated CI score. These CI scores may be predefined as a product (or process) to be used at the farm 702. For example, the end-product fertilizer that the farm uses may have received a final CI score during its manufacturing process. This final CI score may be referenced here as the first step in the supply chain.

Additionally, at farm 702, different “farms” may have different calculations based on soil differences, fuel availability, tillage differences, etc. In some examples, multiple farms may receive different CI scores based on each individual farm's unique inputs (e.g., fertilizer, pesticide, fuel, tillage, etc.). This is illustrated by the grouping of farms 2, 3, 4 . . . below the initial farm 702.

Once the product (e.g., bushel of corn) is harvested and placed into a storage bin, an aggregate CI score may be assigned to the bin (or, in alternative scenarios, assigned to the bushel of corn directly, so as to prevent fraudulently replacing the actual goods in the bin to manipulate CI scores in the supply chain), which is reflected at bin 704. Bin 704 shows a single CI score assigned to a product that contains the inputs of fertilizer, pesticide, fuel, etc. Similarly, for farms 2-4 etc., the products may receive an aggregate CI score at the bin stage.

Following the bin 704 (e.g., bushel of corn), the product is then transmitted to a processing plant 706. At processing plant 706, additional inputs are attributed to the production of the product, such as gas, electricity, water (H₂O), etc. These inputs are measured and analyzed in determining the derivative CI score from the processing plant for the fuels produced at a given time. As described previously, the CI score formula may consider different factors, such as the amount of water used by the processing plant, whether the machinery is powered via gas or electricity, etc. in determining the CI score for that particular step in the supply chain.

After the product (e.g., corn) is processed at processing plant 706, the end-products that may be produced may each receive individual CI scores. For instance, the co-product/byproduct of corn processing may be ethanol alcohol, isobutanol, isooctane, jet fuel, DDG (dried distillers grains, i.e., high protein livestock feed), oil, etc. Each of these products have unique processing requirements that are applied at processing plant 706. As such, each of these byproducts will be associated with a unique CI score based on how they were manufactured. In some examples, the CI score may also indicate how eco-friendly the byproduct is when it is consumed. For instance, ethanol may have a lower CI score compared to jet fuel because burning ethanol-based gasoline produces less CO₂ emissions than burning jet fuel. In other instances, the ethanol could have a higher CI score than the jet fuel.

Additionally, each co-product's and/or byproduct's (ethanol, isobutanol, isooctane, etc.) CI score may be verified using a checksum function that adds the intermediate CI scores together to reach a whole. For instance, a final CI score may be the sum of each intermediate CI score that was assigned to the product through each step in the supply chain. Specifically, the CI scores associated with each component input at farm 702 may be summed into the CI score at bin 704. The aggregate, intermediate CI score at bin 704 may then be added to the CI scores associated with the amount of gas, electricity, water, etc. utilized at processing plant 706. In other examples, each step in the supply chain may produce its own additional CI score that will be summed at the final supply chain step to obtain the final CI score. In this instance, the checksum function can refer to the previous CI scores (which are stored as blocks in the blockchain) to check that the final CI score is the sum of all the previous intermediate CI scores. Ultimately, a sustainability certificate may be issued that describes (and guarantees) the carbon footprint of a fuel product.

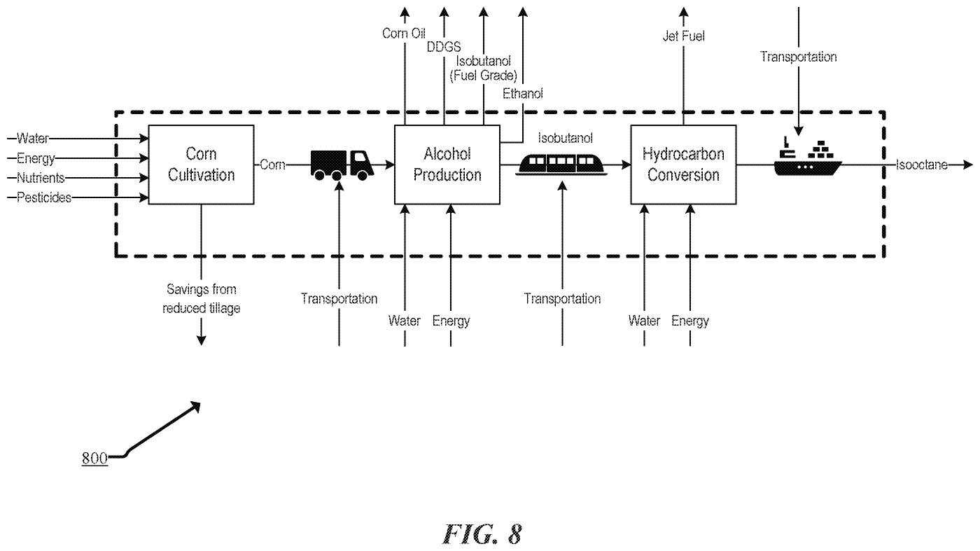

FIG. 8 illustrates example inputs and outputs used to automatically generate and track a CI score along a supply chain. Environment 800 is an example supply chain illustrating the processing steps for corn and its potential co-products and byproducts. As described previously, each discrete step in the supply chain may be assigned a CI score (an intermediate CI score). The end co-product/byproduct may receive a final, validated CI score that may be verified by summing the previous CI scores stored as blocks on a blockchain by applying a checksum function (described in FIG. 7). Here, in environment 800, the initial inputs include water, energy, nutrients, and pesticides. A co-product of the initial inputs may be savings from reduced tillage for the corn cultivation. The savings from reduced tillage may translate to a lower CI score at the corn cultivation step in the supply chain illustrated in FIG. 8. Following the corn cultivation step, the corn is then placed into bins and transported to a production facility, in this example. At the alcohol production facility, more water and more energy may be added as inputs to the process in the supply chain. Example co-products from the alcohol production step may be corn oil, dried distillers grains (DDGS), isobutanol, ethanol, etc. Each co-product may be assigned a CI score based on the sum of the previous CI scores from the previous steps in the supply chain. In the example from environment 800, one of the products from the production step is isobutanol, which may be used in transportation. Isobutanol may also serve as an ingredient for manufacturing hydrocarbon fuel and other chemical products. Further, other products from the production step in the supply chain may be sent to the hydrocarbon conversion processing step in the supply chain. Again, at this step, more water and energy may be input into that step. The output of the hydrocarbon conversion step may hydrocarbon fuels, such as jet fuel, gasoline, diesel, and bunker fuel, wherein the hydrocarbon fuel product will be assigned a CI score that can be validated and audited by adding the previous intermediate CI scores together to obtain a final, validated CI score for the end-product (e.g., jet fuel). In other example aspects, chemical byproducts may include isobutylene, paraxylene, isooctane, and/or other hydrocarbon-based chemical products.

As mentioned previously, the CI scores may be stored on a blockchain and may be fully auditable by looking at the blockchain ledger of nodes pointing to reference nodes containing data associated with intermediate CI scores.

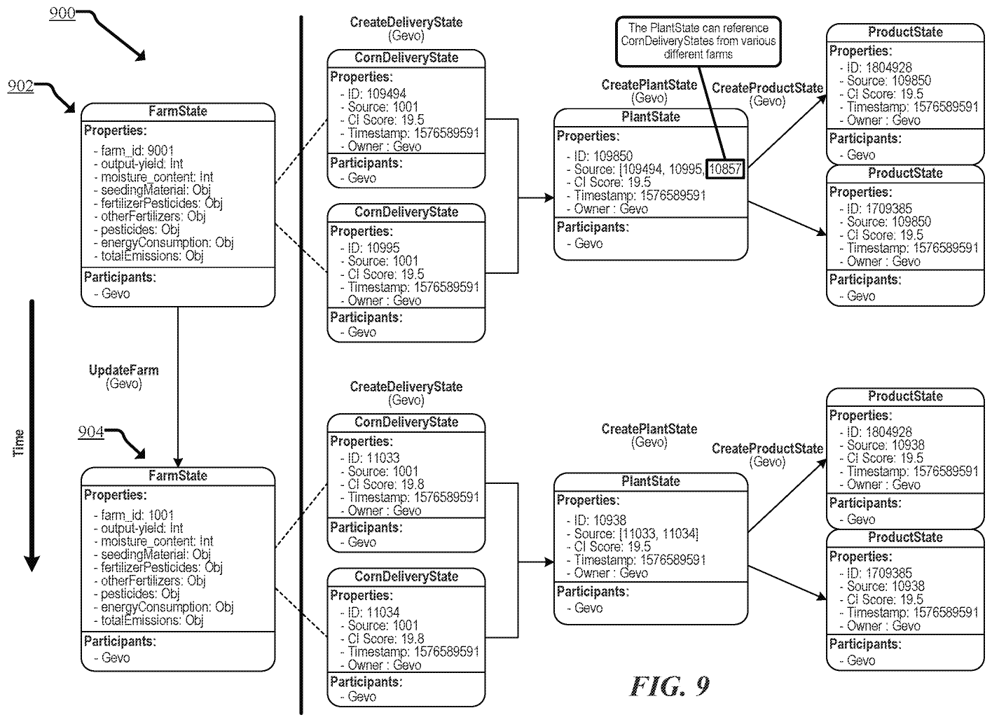

FIG. 9 illustrates an example state diagram used for automatically generating and tracking a CI score. Environment 900 illustrates different states of different participants/stakeholders in an example supply chain (e.g., the supply chain illustrated in FIG. 8). In this example in FIG. 9, two farm states are displayed-farm state 902 and farm state 904. Each farm state includes objects, such as an identifier, output yield, moisture content, seeding material, fertilizer pesticides, other fertilizers, pesticides, energy consumption, and total emissions, among other objects. Each of these objects are used as inputs into the CI score calculation formula. Any asset (e.g., output) may be tracked through the distributed ledger technology systems and methods described herein, such as fuel-related, biogas, wind, solar, hydrogen, water, farm-related (e.g., fertilizer types, herbicides, pesticides, farm-internal life cycle optimization, water usage, ground water protection, etc.), and/or chemical/material assets. For instance, a higher totalEmissions object may increase the CI score of farm state 902, whereas a lower totalEmissions object at farm state 904 may decrease the CI score. As depicted in FIG. 9, the states of each participant in the supply chain may change over time. For instance, if a farm upgrades its machinery or tilling processes, farm state 902 may be updated to farm state 904. Each state may comprise unique properties that reflect its current state. Once a new state is created, it may contain a list of certain identifiers associated with a linked state. For example, a PlantState may contain a list of identifiers from which a product (e.g., corn) was harvested, and the product may have a source identifier that points back to a previous state.

As a certain product is transmitted and processed from step to step in the supply chain, more states of each participant are recorded and linked to each other. For instance, when the product is delivered from the farm to a shipping company, a delivery state (e.g., CornDeliveryState) may be created. The CornDeliveryState data block may include objects such as ID, source of delivery, CI score, timestamp, and owner. In one example aspect, when the corn is moved from one step in the supply chain (e.g., farm) to the next step (e.g., shipper), a CI score is updated and/or assigned. As illustrated in FIG. 9, the CornDeliveryState displays the first time a CI score is assigned to a product. The CI scores for each delivery state may be different depending on the input data received from the farm state. Similarly, plant state reflects a state of a combination of certain batches of products together in this example environment 900. For example at a processing plant, the processing plant may combine multiple CornDeliveryStates into a single PlantState because the processing of this product will happen in a larger volume of corn (hence the multiple CornDeliveryStates). Following the processing steps at the plant, byproducts may be created that each have a ProductState, which point back to the PlantState. Based on the processing inputs at the plant and the information received from the PlantState, a CI score can be derived for ProductState. In some examples, ProductState may be the final, validated product that comprises a final CI score.

Regarding the overall architecture, the states of each participant/stakeholder in the supply chain may be represented as blocks in a blockchain. Each state may be a block appended to a blockchain accessible by the participants in the supply chain, as well as end customers seeking to verify the authenticity and accuracy of a final CI score (and ultimately verifying the value of a CI token). When a state of a participant is updated, a new block may be appended to the blockchain, pointing back to the previous state, so that other stakeholders in the supply chain (e.g., shipping company, processing plant, etc.) know to retrieve data from the most recent block in the blockchain associated with that particular participant in the supply chain. For instance, one way this is implemented programmatically is by checking if a certain block has a forward pointer. If no forward pointer exists, then the present block is the most current block, i.e., the most current state of the participant in the supply chain.

In some example aspects, each state may be indicative of a block in a blockchain. When a verifier/requestor desires to verify the CI score of an end product, the verifier/requestor may not only receive the validated CI score (which is one of the properties of a state), but also each of the other properties for that state, as well as the referenced states that are captured by other blocks in the blockchain (i.e., linked to the present state). For instance, a verifier may first receive data from the ProductState, showing the CI score and other properties associated with that ProductState. The verifier may then elect to analyze the previous state by tracing the back-pointer from the ProductState to the PlantState and receiving the properties data from the PlantState. From there, the verifier may receive data from the other available states, including CornDeliveryState and FarmState. This example is not limiting and may be extrapolated to other industries and products that utilize a multi-step supply chain. At each step in the supply chain, a state is captured, wherein a CI score is one property of that state, and the properties serve as inputs in calculating the subsequent CI score to be recorded in that state.

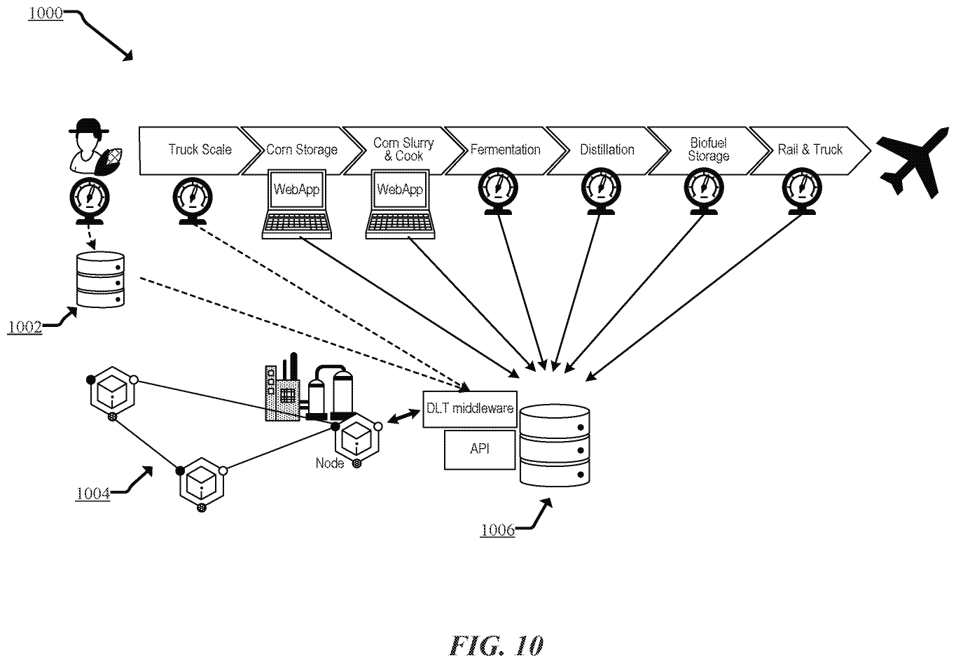

FIG. 10 illustrates an example environment from which data is captured for automatically generating and tracking a CI score. FIG. 10 illustrates another example environment 1000 showing different steps in a supply chain and how each participant in the supply chain may communicate with each other, verifying each other's CI scores and producing updated CI scores as the product traverses through the supply chain. For example, a farmer may initially input information locally to a database 1002. This information may be utilized by the system described herein to create an initial FarmState (as described in FIG. 9). The FarmState may be created and propagated throughout the network to other participants in the supply chain via blockchain network 1004. Copies of the FarmState may also be accessed via central database/servers 1006, wherein an application programming interface (API) and distributed ledger technology (DLT) middleware (e.g., DeFi applications) may run. For example, the tuck scale participant in the supply chain may desire to access the FarmState information for a particular product being received from the farmer. To receive this information and verify the initial CI score of the product, the truck scale participant may access the blockchain network 1004 via a DeFi application interface that also utilizes central (and distributed) databases/servers 1006. The system may return a copy of the FarmState to the truck scale participant, and in turn, the truck scale participant may input its processing information, and a new state (e.g., TruckScaleState) may be created that is based on the information from the FarmState and the truck scale participant's input data.

As illustrated in FIG. 10, the input data that comprises the states of each participant in the supply chain may be obtained via a web application interface (e.g., user interface of a DeFi application running on top of a blockchain network, e.g., network 1004. In other examples, the input data may be received from IoT devices that are affixed to certain machines, storage containers, pipes, etc. that measure certain carbon emissions, in one example. These IoT devices automatically measure and report data to a central system, where the system uses that data to create a state of a participant in the supply chain. Further, as noted earlier, each state may be updated for each product that flows through the supply chain. States may change as frequently or infrequently as the participants desire. For example, a farmer may have run out of a certain eco-friendly fertilizer one day and so is forced to apply a less-“green” fertilizer. This change (although only for one day) may be captured in an updated state data block that is ultimately considered in the final calculation of a CI score.

FIG. 10 may also comprise a third-party verification entity, wherein the third-party verification entity is a node within blockchain network 1004. The third-party verification entity may act as a notary (i.e., independent signer) that may close and confirm certain transactions and submissions to the blockchain. Such third-party verification may prevent double-spending (e.g., an entity may attempt to double-spend a CI token, a participant in the supply chain may attempt to falsify an intermediate CI score by copying a lower CI score from a previous block and attempting to use that block's information in the supply chain rather than the previous block displaying the higher intermediate CI score, etc.).

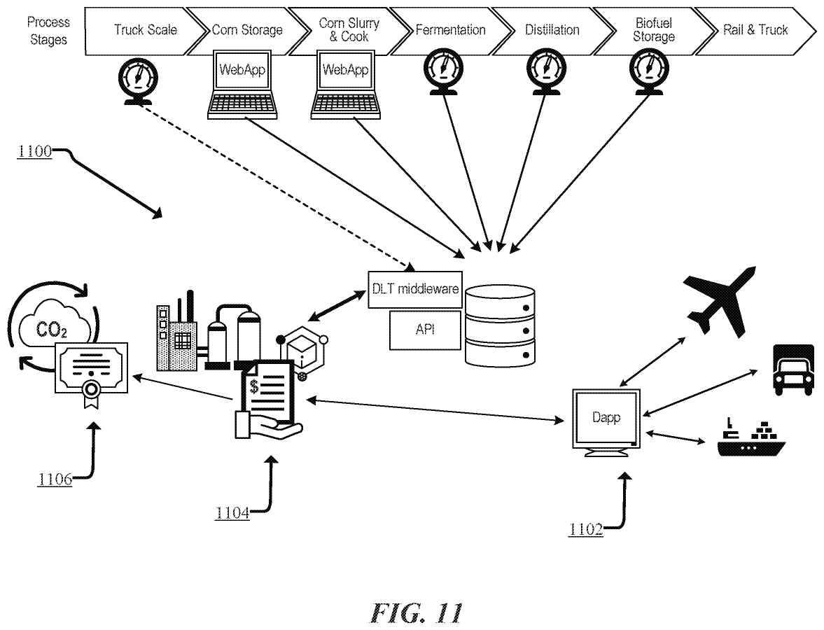

FIG. 11 illustrates an example environment for automatically generating and validating a CI score. The example environment 1100 in FIG. 11 shows the same supply chain from FIG. 10. Environment 1100 also illustrates a Dapp (decentralized application) 1102 that an end customer may utilize to pay a supplier. Dapp 1102 may be utilized to query a blockchain (such as blockchain network 1004) to verify the final CI score of a certain product. If the CI score is verified (e.g., via a CI score certificate 1106 produced by validating the CI scores on the blockchain), then the supplier may receive money from the end customer. As described earlier, this transaction may be executed automatically via a smart contract. For instance, the terms of the smart contract may specify that once a certain end product has been validated as having a certain CI score, then certain escrowed funds from a buyer may be transferred to a seller. The verification process of a CI score may occur via querying the blockchain and analyzing each state data block leading up to the final product (i.e., auditing the CI score's evolution from when the product was first grown to its final processing steps prior to becoming an end-product for the buyer).

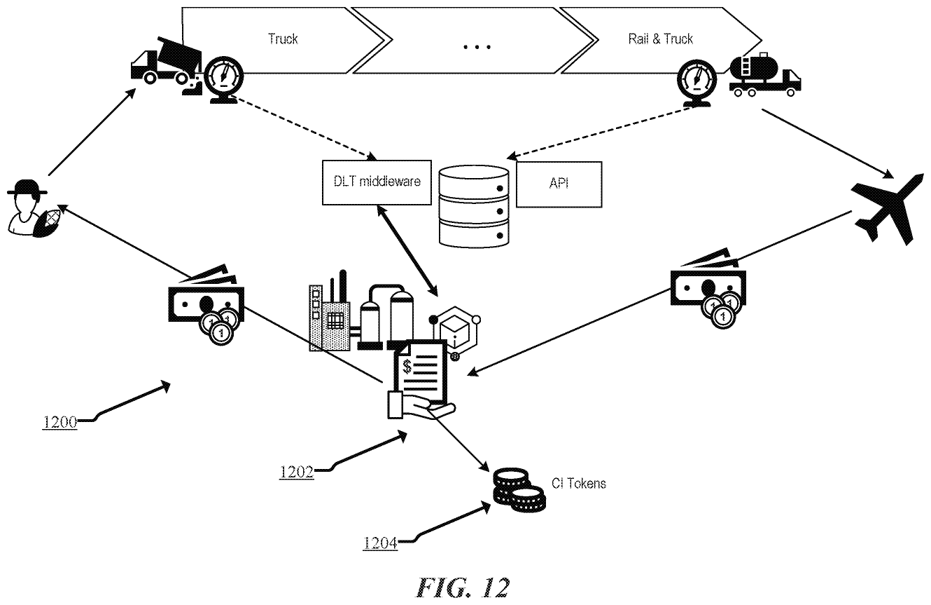

FIG. 12 illustrates an example environment for generating a CI token via a CI score. After a certain co-product is validated as having a certain CI score, the validated CI score (e.g., in the form of a certificate generated from the blockchain) may be used to create a CI token, which may represent a value of carbon offset credits that may be traded. For example, after money is transmitted from buyer to seller due to the validation of a CI score of a certain product, a verified and immutable record now exists that certain carbon emissions were avoided by utilizing eco-friendly processes throughout the supply chain. The CI score (and the accompanying state data blocks with properties) may reflect this. As a co-product of tracking the CI score and purchasing a product with a low CI score, a CI token that captures the value of the avoided carbon emissions may be created. This is akin to a carbon credit that may be bought and sold among parties. Preferably, the CI tokens are fungible tokens so they are all identical, yet divisible into smaller units, and can be readily exchanged.

Specifically, a CI token may be sold to a company that wishes to emit a certain level of carbon emissions and to pay for the carbon emissions via a CI token. A CI token is a measurable, verifiable emission reductions store of value that may permit an entity to emit certain carbon emissions if the entity can pay for the carbon emissions via a CI token. In essence, a CI token is a tradable cryptocurrency that allows its holder to emit a certain amount of carbon emissions that is on par with the value of the CI token. CI tokens may also function as a common denominator currency between market sectors (e.g., facilitating transactions between agricultural entities and electricity providers).

Certain buyers of eco-friendly products may pay premium prices for products with verified low CI scores. To offset this premium amount paid, the buyers may also receive a CI token, which may be sold by the buyers to other entities wishing to emit excess carbon emissions that they otherwise may not be permitted to emit based on regulations and laws in certain jurisdictions. As such, a low CI score translates to a higher value CI token.

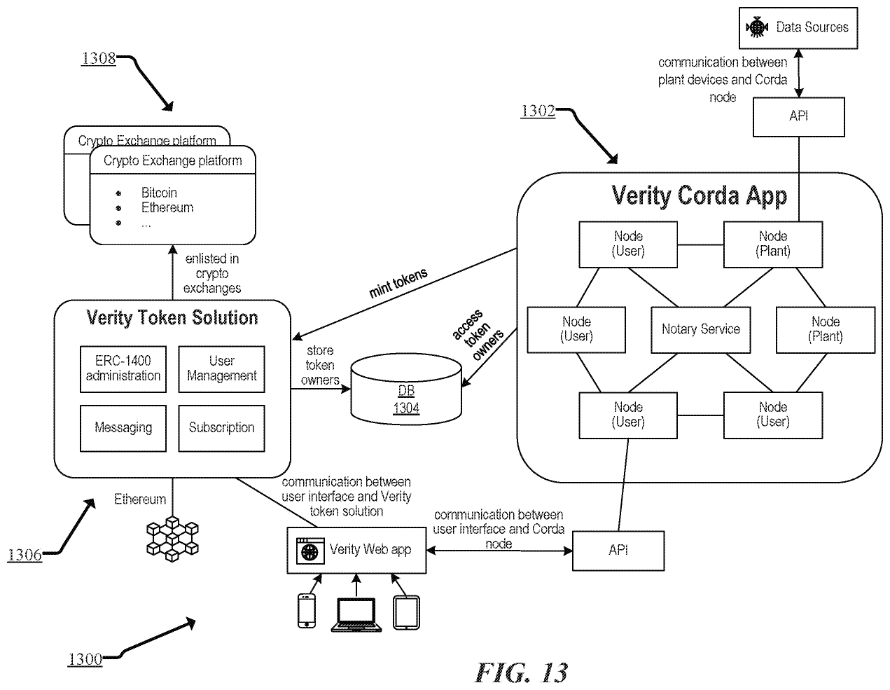

FIG. 13 illustrates an example environment for generating and trading a CI token using, at least in part, the Corda® blockchain development platform available from R3 Ltd. In this specific implementation, environment 1300, referred to as “Verity”, combines a large and transparent voluntary carbon credit market with a supply-management system that ensures the reliability of low, neutral, and/or negative carbon intensity of the production of materials through an immutable and automated audit using blockchain technology. Verity's blockchain-based system offers one single source of truth across production value chains, wherein each economic actor interacts with other economic actors in the system. This interaction allows all parties to record and manage agreements amongst themselves in a secure, consistent, reliable, private, and auditable manner.

In Verity, each participant may be a famer, plant, distributor, etc. Each participant runs a node within the Corda® application 1302. Each node communicates to external data sources via an API, retrieving production data to calculate a CI score at each stage in the supply change. Each Corda® node may also receive algorithmic information related to a GREET model (Greenhouse gases, Regulated Emissions, and Energy use in Technologies) in order to calculate a CI score.

Producers may calculate their CI scores and retrieve the value of their sustainable practices via a market, which may be referred to as the “Verity Carbon Market.” CI scores may be transmitted and stored in database 1304, which then communicates to Verity Token Solution 1306. Participants may tokenize their CI scores via the Verity Token Solution 1306. Such tokens may be Direct Carbon Value (DCV) tokens that are minted based on calculations of the CI scores within the Verity platform and are tradable among network participants. Verity tokens may ultimately be traded and exchanged on a cryptocurrency exchange platform 1308. Because Verity source data is extracted directly from the supply chains of each economic actor in the Verity network, there is certainty associated with each carbon offset (i.e., no double-counting).

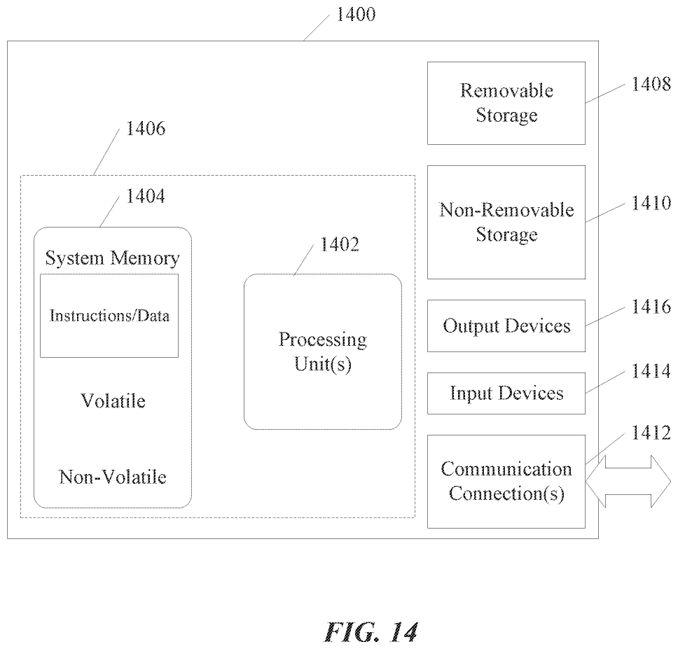

FIG. 14 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 1400 typically includes at least one processing unit 1402 and memory 1404. Depending on the exact configuration and type of computing device, memory 604 (storing, among other things, information related to devices, blockchain networks, payment settings, asset balances, CI score formulas, ML-based suggestions for decreasing CI scores, and instructions to perform the methods disclosed herein) may be volatile (such as RAM), non-volatile (such as ROM, flash memory, etc.), or some combination of the two. This most basic configuration is illustrated in FIG. 14 by dashed line 1406. Further, environment 1400 may also include storage devices (removable 1408 and/or non-removable 1410) including, but not limited to, magnetic or optical disks or tape. Similarly, environment 1400 may also have input device(s) 1414 such as keyboard, mouse, pen, voice input, etc., and/or output device(s) 1416 such as a display, speakers, printer, etc. Also included in the environment may be one or more communication connections, 1412, such as Bluetooth, WiFi, WiMax, LAN, WAN, point to point, etc.

Operating environment 1400 typically includes at least some form of computer readable media. Computer readable media can be any available media that can be accessed by processing unit 1402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures (e.g., blockchains), program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 1400 may be a single computer (e.g., mobile computer) operating in a networked environment using logical connections to one or more remote computers. The remote computer may be a personal computer, a server, a router, a network PC, a peer device, an IoT measurement device (E.g., carbon emissions measurement device), or other common network node, and typically includes many or all of the elements described above as well as others not so mentioned. Any of these operating devices may be part of a larger blockchain network (as illustrated in FIG. 2). The logical connections may include any method supported by available communications media. Such networking environments are commonplace in offices, enterprise-wide computer networks, intranets, and the Internet.

A current implementation of the teachings herein has been developed, in part, utilizing the open source Corda® enterprise blockchain platform for the supply side management (SSM) component. Corda® presents an attractive development platform due to its proficiency at interconnecting IoT device or a process information (PI) system for recording, analyzing and monitoring real time information. Furthermore, Corda® works with standard REST APIs for the plant control system. Another appealing feature of Corda® is its improved ability to establish tokens within their platform. This makes it currently a more attractive platform over others, such as Hyperledger Fabric which has deprecated its token SDK. Another advantage of using Corda® is its utilization of an unspent transaction output (UTXO) model, where each state on the ledger is immutable. That said, the ordinarily skilled artisan will recognize and appreciate that other open source or propriety blockchain architectures and protocols, or combinations thereof, could be utilized to achieve the benefits described herein.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

We claim:

1. A method comprising:
before a step in a process for converting feedstock into biofuel, a processor:
obtaining a carbon intensity (CI) score for a product being provided to the step; and
using the CI score to select a power source for the step;
applying the product to the step in the process using the selected power source; and
completing any remaining steps of the process to produce the biofuel.

2. The method of claim 1 further comprising, during the process for converting the feedstock into biofuel, determining which of a collection of power sources are available for performing the step wherein selecting a power source for the step is limited to selecting a power source from the available power sources.

3. The method of claim 2 wherein the collection of power sources is limited to power sources that have been implemented at the facility being used to convert the feedstock into the biofuel.

4. The method of claim 1 wherein selecting the power source comprises selecting a power source to obtain a desired CI score for the biofuel.

5. The method of claim 2 wherein determining which of a collection of power sources is available comprises tracking a status of each power source implemented at the facility while performing a step in the process that produced the product.

6. The method of claim 1 wherein producing the biofuel further comprises producing an immutable CI score for the biofuel that reflects the carbon intensity associated with growing the feedstock, transporting the feedstock and converting the feedstock into the biofuel.

7. The method of claim 6 further comprising:
generating a CI token based on the CI score for the biofuel; and
using the CI token to offset at least one instance of carbon emissions.

8. The method of claim 7 wherein using the CI token comprises marking the CI token so that the CI token cannot be used to offset other carbon emissions.

9. A method comprising:
before a process for creating biofuel, a processor obtaining a respective carbon intensity (CI) score for each of a plurality of loads of feedstock present at a processing plant configured to create biofuel and using the CI scores for the plurality of loads of feedstock to select a load of feedstock to use in the process for creating biofuel; and
applying the selected load of feedstock to the process to produce the biofuel.
